(19) United States
(12) Patent Application Publication
(10) Pub. No.: US 2008/0299271 A1
(43) Pub. Date: Dec. 4, 2008

(54) LIQUID FOODS AND PROCESS FOR PRODUCING THE SAME

(75) Inventors: Takashi INOUE, Aichi (JP); Wakako Kato, Aichi (JP); Kenji Yamaguchi, Aichi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Pokka Corporation, Aichi (JP)

(21) Appl. No.: 12/187,800

(22) Filed: Aug. 7, 2008

Related U.S. Application Data
(63) Continuation of application No. 10/481,894, filed on Jan. 5, 2004.

(30) Foreign Application Priority Data
Jul. 5, 2001 (JP) 2001-205250
Jul. 5, 2001 (JP) 2001-205369
Sep. 28, 2001 (JP) 2001-301152

(51) Int. Cl. A23L 3/32

(52) U.S. Cl. 426/237

(57) ABSTRACT

The invention is to provide a process for producing a liquid food, characterized by subjecting at least one of coffee, a milk composition, a food material (liquid) containing a component(s) having an antioxidation ability (radical-scavenging activity) and mixed liquids containing one(s) of them to an electrolysis treatment and/or a current passage treatment. Since the invention can prevent quality deterioration of coffee or milk composition over a long period of time without using additives and also improve safety, it is appropriate for producing canned coffee, milk-containing coffee or milk-containing tea drink to be sold in vending machines or can warmers. Further, since the invention can improve the antioxidation ability of foods, the resulting foods can suppress the in-vivo increase of active oxygen and free radicals, it greatly contributes to health.

### FIELD TO WHICH THE INVENTION BELONGS

The present invention relates to various liquid foods including drinks and processes for producing the same. More specifically, the invention is characterized in that materials of liquid foods are subjected to electrolysis treatment and/or current passage treatment. The resulting liquid foods retain taste and quality over a long period of time, and further liquid foods having an antioxidation ability (radical-scavenging activity) are also improved in antioxidation ability and available as foods good for health.

### PRIOR ART

Drinks such as coffee, black tea and juice are usually good in taste and quality immediately after brewing, immediately after extraction or immediately after squeeze. However, it is unavoidable that the taste and the quality of products are deteriorated with time due to oxidation, change in temperature or the like. Especially, drinks filled in sealed containers, unlike coffee which is drunk just after brewed and extracted from coffee beans in coffee houses or at home, unavoidably take a certain period of time from production to drinking by consumers.

Not only coffee but also milk coffee (milk-containing coffee), milk tea (milk-containing tea) and other milk composition-containing drinks tend to be decreased instability owing to factors such as pH, oxygen and heat to cause the deterioration of quality. In particular, when these drinks are filled in containers, the drinks filled in sealed containers are decreased in stability even at normal temperatures during the very period to deteriorate the quality thereof. Needless to say, in hot vending, can warmers and vending machines, drinks are stored at high temperatures over a long period of time. Accordingly, the decrease in stability and the deterioration of taste and quality are more accelerated.

Thus, for controlling or preventing the decrease in stability and for controlling or preventing the decrease in flavor and quality, the use of additives and the use of enzymes have been studied, and a part of these have been put to practical use. With respect to coffee, the use of various deterioration preventing agents has been studied. However, satisfactory products have not been actually developed as yet.

Meanwhile, with respect to milk composition-containing drinks, the use of additives can indeed stabilize milk to some extent, but it does not necessarily lead to stabilization because of the difference in conditions of drinks to which milk is added. Further, the use of additives tends to influence taste and flavor. Still further, since there is a recent tendency that the use of many additives or the use of additives in large quantities is not demanded, it has been required to find a method in which the use of additives is controlled.

In recent years, with respect to liquid foods, foods typified by coffee, black tea and the like as described above, in which palatability is important, have been produced, and further various health foods have been produced and sold for maintenance or promotion of health. Thus, liquid foods tend to shift more to those having high effects. In addition, active oxygen and free radicals have attracted much interest because of causes to induce cancers, life style-related diseases, skin disorders and various diseases. In order to suppress the in-vivo increase inactive oxygen and free radicals, food shaving an antioxidation ability have been highlighted, and the functions thereof have been actively studied. Moreover, it has been expected that foods to be eaten themselves have a high antioxidation activity.

### PROBLEMS THAT THE INVENTION IS TO SOLVE

The invention has been made to meet the foregoing needs of those skilled in the art. In view of physical properties and organoleptic properties, it has been made to prevent the decrease in the stability, the taste and the quality of coffee, milk components-containing drinks and other various liquid foods and to maintain or improve the stability, the taste and the quality thereof.

Moreover, the invention has been made to newly develop technology of efficiently producing foods having an improved antioxidation ability without using additives in view of the importance of food shaving a high antioxidation ability, namely, a high radical-scavenging activity and further in view of consumers' needs for safety and for health.

### MEANS FOR SOLVING THE PROBLEMS

In order to attain the foregoing objects, the present inventors have conducted investigations from various aspects. Consequently, they have conducted extensive studies upon focusing on a system of stabilization and prevention of quality deterioration or a system of long-term storage without the use of additives in view of consumers' recent needs that they do not desire the use of chemical additives such as quality deterioration preventing agents.

They have electrolyzed a coffee extract (so-called regular coffee), and have then found that the decomposition, the denaturation and the like of coffee extracted components are improved and the quality can be retained for a long period of time. Further, regarding a mixed liquid obtained by adding various side materials to coffee, other than coffee, the long-term retention of quality by an electrolysis treatment has been confirmed. The investigations have been further continued, and a current passage treatment has been performed instead of an electrolysis treatment. Then, an excellent long-term retention of quality has been likewise confirmed.

They have applied a current passage treatment to milk, and have then found that stability is maintained without quality deterioration such as agglomeration or formation of precipitate and no special organoleptic change occurs in qualities of taste, flavor and the like, so that long-term stabilization and storage are possible. They have further conducted a current passage treatment of a mixed liquid obtained by adding milk to coffee (coffee milk), and have then found that excellent effects of maintaining stability, flavor and quality have been likewise brought forth. Investigations have been further continued, and it has been confirmed that an electrolysis treatment other than a current passage treatment is also available.

During these studies, the present inventors have broadened the range of studies, and have electrolyzed liquid foods having an antioxidation ability, which foods are known as health components. Consequently, they have found for the first time that an antioxidation ability is improved, that when a component having an antioxidation ability is contained even in a small amount, the effect of improving the antioxidation ability is provided, and that these effects are likewise provided by a current passage treatment. As a result of further investigations based on these useful new findings, the invention has been finally completed.

The invention is described in detail below.

In practicing the invention, a main material of a desired liquid food and/or a mixed liquid prepared by adding a side material(s) to the main material is subjected to an electrolysis treatment or a current passage treatment or both of these treatments. With respect to these treatments, a current passage treatment and/or an electrolysis treatment may be conducted in one position of steps from a material to a final liquid food product through a mixed liquid or not therethrough, the treatment(s) may be conducted in two or more positions thereof, and a current passage treatment and an electrolysis treatment may be conducted by the respective same treatments or a combination of different treatments. Further, components for preparing the main material and the side materials may be previously subjected to a current passage treatment and/or an electrolysis treatment as required.

In the invention, the foods include drinks also. Thus, the liquid foods are sometimes called drinks.

First of all, for producing coffee drinks according to the invention, it is necessary to prepare a liquid containing extracted components of coffee. This liquid includes all of coffee, namely, an extracted liquid obtained by brewing and extracting roasted coffee beans by various methods and all of liquids containing components extracted from coffee. For example, it includes all of extracts obtained by varying extraction conditions such as an extraction temperature, concentrated liquids thereof, dilute liquids thereof, component fraction liquids obtained by fractionating a specific fraction(s) therefrom, component fraction liquids obtained by removing specific fraction(s) through fractionation, such as a decaffeinated coffee, and a solution of instant coffee, etc.; namely it includes all of liquids prepared by using water or hot water (0 to 200° C.), containing components extracted from coffee.

In extracting coffee, a blending ratio or a roasting degree of coffee beans is not particularly limited, and may be properly determined in a usual manner. An extraction method is not particularly limited either. An extracted liquid or an extract obtained through a drip method, a box method, a continuous multi-column method, a kneader method or the like can be used. An extraction temperature is not particularly limited either. Further, an extracted liquid, an extract, a concentrated liquid, a dilute liquid, a solution of instant coffee and the like may be subjected, as required, to fractionation such as chromatography to obtain a specific fraction(s) or remove a specific fraction(s).

The mixed liquid in the invention is prepared by adding a side material (s) to a liquid containing the foregoing coffee extracted components and adjusting the product volume. The side material includes all of side materials free of milk composition. Examples thereof include pH adjustors such as sodium bicarbonate; vitamin C, vitamin E; emulsifying agents such as sucrose fatty acid ester, glycerin fatty acid ester, sorbitan fatty acid ester and soybean phospholipid; oxidation inhibitors; antioxidants; saccharides such as glucose, fructose, maltose, sucrose, trehalose, raffinose and starch; sugar alcohols such as erythritol and maltitol, sweeteners; flavors; enzymes; and the like. One or more thereof are selectively used.

The thus-obtained liquid containing the coffee extracted components and/or its mixed liquid is then subjected to an electrolysis treatment and/or a current passage treatment.

A device used in conducting an electrolysis treatment is not particularly limited so long as it is a device used for decomposing water or the like. For example, a two-cell system in which two cells are partitioned via a diaphragm or a three-pole system in which a DC voltage is switched over by a flip-flop circuit can be used without problem. The two-cell system includes a type in which electrolysis is conducted for a certain period of time and a running water type. Examples of the diaphragm include an ion exchange membrane and a neutral diaphragm such as a cellulose membrane.

In the electrolysis method using the ion exchange membrane or the neutral membrane, a liquid containing coffee extracted components and/or its mixed liquid with the same composition as that on the cathode side (region), or water containing minerals may be passed through the anode side (region). As the water containing minerals, a ground water, a city water, and a water prepared by adding various minerals properly to a pure water may be used. Examples of the minerals can include sodium, potassium, magnesium, calcium and iron, and further these minerals may be used in combination.

The current passage treatment can be conducted by removing the diaphragm at the time of the treatment.

With respect to the electrodes, for example, a ferrite electrode, a platinum-plated titanium electrode, a titanium platinum calcination electrode and the like can be used as an anode, and a stainless steel electrode, a platinum-plated titanium electrode, a titanium platinum calcination electrode and the like can be used as a cathode.

The electrolysis is conducted in a usual manner by passing a DC current in a state where a liquid such as a liquid containing extracted components is continuously passed and/or stays between two electrode sides. A quantity of a current is at least 0.1 A, preferably from 1 to 50 A. The quantity of the current is properly determined depending on factors such as conductivity, distance between the electrodes and density. For example, in the case of a liquid flow rate of 4 L/min, the quantity of the current is from 0.5 to 20 A, preferably from 1.0 to 10 A, more preferably from 1.5 to 7 A. In other cases, it may be determined on the basis of this quantity of the current.

The current passage treatment can be conducted by removing the diaphragm in the foregoing case. The quantity of the current passing through the liquid is the same as in the foregoing case. The time for current passage is likewise from 0.001 second to 5 minutes, preferably from 0.005 seconds to 2 minutes. These numerical ranges are tentative standards, and the conditions might be sometimes deviated from the foregoing ranges.

The electrolysis treatment and/or the current passage treatment may be applied to

(1) a liquid containing coffee extracted components and/or

(2) a mixed liquid containing a side material(s) either before or after adjusting the product volume.

The electrolysis treatment and the current passage treatment may be applied to (1) or (2), or to both of them. The number and the combination of these treatments are not particularly limited.

In the invention, extraction water used for extraction of coffee and other various waters to be used as materials are not subjected to the electrolysis or current passage treatment, but the invention is characterized in that an extracted components-containing liquid such as a coffee extracted liquid obtained by extracting coffee with extraction water is subjected to the electrolysis or the current passage treatment. The reason why the electrolysis or the current passage of the extracted components-containing liquid is preferable to the electrolysis or the current passage of the waters is that the direct electrolysis or the current passage of the extracted liquid or the mixed liquid more influences the components than the electrolysis or the current passage of the waters, making it possible to maintain the effects for a long period of time.

The invention may be also practiced in a deoxidated condition, and the deterioration of components is not caused by virtue of deoxidation. That is, when an oxidative deterioration is more prevented by deoxidation, the change of components less occurs, a quality deterioration can be suppressed, and this is quite effective for maintaining coffee good in taste and flavor over a long period of time.

The practice in the deoxidated condition includes each treatment in an inactive gas atmosphere, blowing of an inactive gas through a material (s), an intermediate product and a final product, replacement of inside oxygen with an inactive gas and degassing. Further, in the case of filling the liquid in a container, it includes replacement of air in a filling container with an inactive gas, replacement of air in a head space with an inactive gas and degassing. At least one of these treatments for removing oxygen can be exemplified.

The thus-obtained liquid is filled in containers such as cans, bottles, papers, PET bottles and soft packaging containers, and sealed, and then pasteurized as required to provide drinks filled in sealed containers.

When the liquid is filled in containers to withstand retorting (heat pasteurization under pressure), it is filled in containers, sealed, and then pasteurized in a retort.

With respect to drinks whose flavor is heavily changed due to heat of pasteurization in a retort or the like or drinks incapable of pasteurization in a retort, a charging liquid is subjected to UHT pasteurization or other flash heat pasteurizations, then filled in containers, and sealed.

When freeze-storage is employed or long-term storage is not needed after production of drinks, the liquids may be filled in containers without pasteurization.

The above-obtained drinks filled in sealed containers may be stored at room temperature or by being refrigerated, heated or frozen as required.

With respect to the coffee drinks according to the invention, the non-limitative embodiments are described below.

### EMBODIMENT 1

A process for producing a drink, characterized by subjecting a liquid containing a coffee extracted components and/or a mixed liquid thereof to electrolysis treatment or current passage treatment.

### EMBODIMENT 2

The process recited in embodiment 1, characterized in that in the electrolysis, a liquid on a cathode side (reduction side) is collected.

### EMBODIMENT 3

The process recited in embodiment 1 or 2, characterized in that the liquid containing the coffee extracted components is at least one selected from an extracted liquid, an extract, a concentrated liquid, a dilute liquid, a component fraction liquid and a solution of instant coffee.

### EMBODIMENT 4

The process recited in any of embodiments 1 to 3, characterized in that the process is performed in a deoxidated condition.

### EMBODIMENT 5

A drinks retaining flavor and quality over a long period of time even at high temperatures, which is produced by the process according to any one of embodiments 1 to 4.

### EMBODIMENT 6

The drink recited in embodiment 5, characterized in that the retention of the flavor and the quality is at least one of suppression of decrease in chlorogenic acid and suppression of formation of organic acids.

Production of milk-containing drinks is described below.

In one of embodiments when producing milk-containing drinks according to the invention, a milk composition can be subjected to the current passage treatment and/or the electrolysis treatment. As the milk composition, at least one of raw milk (cow's milk), processed milk, skim milk powder, whole milk powder, skim milk and concentrated milk is mentioned. A liquid containing the same, a liquid obtained by dissolving powder in water or hot water, each concentrated liquids or each dilute solutions of these liquids, and the like are also included in the milk composition. Further, an emulsifying agent, a stabilizer such as cellulose or sodium caseinate, and the like may be added to the milk composition.

The milk composition is subjected to the electrolysis treatment and/or the current passage treatment to obtain a reduced milk material. By the treatment(s), the raw milk feel of the milk composition is improved, the taste is enriched, and stabilization is also attained.

The electrolysis treatment and the current passage treatment of the milk composition are performed in the same manner as in the foregoing coffee drinks. Incidentally, these treatments are not only applied to the milk composition but also conducted in each step of the invention.

The milk composition is treated by at least one of electrolysis and current passage. One and the same treatment may be repeated at least twice, as required, as described previously, or a combination of the different treatments may be conducted plural times. In the electrolysis treatment, protein is adhered to an ion exchange membrane or a neutral membrane to heavily deteriorate the membrane itself. For this reason, it is usually efficient to perform the current passage treatment.

The milk composition is treated in this manner to obtain the milk material. A drinks is produced by an ordinary method which comprises adding the milk material to an extracted liquid of coffee, black tea, green tea or Chinese tea or a liquid containing the extracted liquid, and mixing them. The resulting product is a milk-containing drink having a good milk stability. That is, milk is stabilized during the production to provide a product having an excellent quality with an improved stability over time in long-term storage. Further, the drink can be produced in which a rich taste is enhanced, a raw milk feel tends to remain and the taste and the flavor of milk are improved.

A drinks can also be produced by subjecting a mixed liquid containing the milk composition to the electrolysis treatment and/or the current passage treatment. The milk composition added at this time may be one subjected to the electrolysis treatment and/or the current passage treatment (for example, the foregoing milk material) or one not subjected thereto. For making good the stability of a milk of final drink, it is preferable that the drink is produced by adding the milk composition subjected to the electrolysis treatment and/or the current passage treatment.

In the invention, the mixed liquid is prepared by adding, besides the milk composition, a side material(s) to a main material of a desired drink, such as a coffee liquid, a tea liquid, juice or the like, and adjusting the product volume. As the side material(s), for example, one or more side materials used to produce coffee drinks are used.

The mixed liquid is then subjected to the electrolysis treatment and/or the current passage treatment, and desired steps such as filling in containers and pasteurization are conducted as required to produce desired drinks. In the invention, the milk composition is previously subjected to the electrolysis and/or the current passage (for example, the foregoing milk material), or the mixed liquid containing the milk composition (which may be previously subjected to the electrolysis and/or the current passage) is previously subjected to the electrolysis and/or the current passage. Desired drinks can also be produced effectively by using them as required.

The milk-containing drinks to which the invention can be applied may be all drinks to which the milk composition is added. Examples thereof include a milk-containing coffee, a milk-containing tea drink, a milk-containing juice, milkshake, cocoa, an acidic milk drink and soup. Especially, coffee drinks or tea drinks are preferable.

The invention may also be practiced in a deoxidated condition, and the deterioration of components is not caused by virtue of deoxidation. That is, when an oxidative deterioration is more prevented by deoxidation, components are less changed, and the deterioration of quality can be suppressed. It is quite effective for maintaining the milk-containing drinks good in taste and flavor over a long period of time.

The thus-obtained liquids are filled in containers and sealed in a usual manner, and, as required, pasteurized to provide drinks filled in sealed containers. The practice in the deoxidated condition and the production of the drinks filled in containers may be conducted in the same manner as in the foregoing coffee drinks.

Although the drinks according to the invention contain the milk composition, occurrence of scale, agglomeration and precipitation of milk components, flotation of milk fat, and the like are suppressed or prevented to stabilize milk, and the appearance is also excellent without observing the deterioration of quality. Further, with respect to organoleptic properties, taste, flavor and quality are excellent without being deteriorated. These effects have been also observed when the drinks have been preserved for a long period of time. In view of both the physical properties and the organoleptic properties, it has been observed that even when the drinks have been stored in a severe atmosphere over a long period of time, the improved property, the stability, the taste, the flavor and the quality of the milk composition are satisfactorily maintained or the deterioration is prevented or suppressed.

With respect to the milk-containing drinks according to the invention, the non-limitative embodiments are described below.

### EMBODIMENT 1

A milk material obtained by subjecting a milk composition to electrolysis treatment and/or current passage treatment.

### EMBODIMENT 2

A milk-containing drink produced using the milk material recited in embodiment 1.

### EMBODIMENT 3

A milk-containing drink obtained by subjecting a mixed liquid containing a milk composition to electrolysis treatment and/or current passage treatment.

### EMBODIMENT 4

A milk-containing drink obtained by subjecting a mixed liquid produced by using the milk material recited in embodiment 1 to electrolysis treatment and/or current passage treatment.

### EMBODIMENT 5

The milk-containing drink according to anyone of embodiments 2 to 4, characterized in that the resulting milk-containing drink is a milk-containing coffee drink, a milk-containing tea drink or a milk-containing fruit juice drink.

### EMBODIMENT 6

The milk-containing drink according to embodiment 5, characterized in that the milk-containing drink recited in embodiment 5 is a drink having an excellent stability with quality deterioration prevented.

### EMBODIMENT 7

A process for producing a milk-containing drink by subjecting a milk composition to electrolysis treatment and/or current passage treatment as required and then preparing or not preparing a mixed liquid containing the milk composition, characterized by comprising at least one of the following:

A: when the milk composition is subjected to the electrolysis treatment and/or the current passage treatment,

(1) directly producing the milk-containing drink using the thus-treated milk composition;

(2) preparing the mixed liquid containing the thus-treated milk composition, and producing the milk-containing drink using the same;

(3) preparing the mixed liquid containing the thus-treated milk composition, further subjecting this to the electrolysis treatment and/or the current passage treatment, and then producing the milk-containing drink using the same; and

B: when the milk composition is not subjected to the electrolysis treatment and/or the current passage treatment,

(4) preparing the mixed liquid containing the milk composition, subjecting this to the electrolysis treatment and/or the current passage treatment, and then producing the milk-containing drink using the same.

As stated above, the present inventors have found for the first time that the electrolysis treatment and/or the current passage treatment gives many prominent effects such as the retention of the taste and the quality of foods and prevention of scales of milk components. As a result of further studies, it has been found for the first time that the prominent effect, different from the foregoing, that these treatments improve the antioxidation ability of foods, is brought forth.

The invention in which the electrolysis treatment and the current passage treatment improve the antioxidation ability of foods has been hitherto unknown and quite unique. Since the resulting foods are useful for suppressing active oxygen and free radicals in vivo, they are said to be foods good for health. Accordingly, the invention also provides such foods good for health.

In the invention, a food material with an antioxidation ability which is known as a health composition and/or the mixed liquid prepared using it is subjected to the electrolysis treatment and/or the current passage treatment. The component having an antioxidation ability includes the following. In the invention, drinks are also included in the food.

In the invention, the following are shown as the component having an antioxidation ability, though they are not limited: vitamins such as vitamin A, vitamin C, vitamin E, carotenoid and lycopene; flavonoids such as isoflavon and eriocitrin (lemon flavonoid); polyphenols such as chlorogenic acid, catechin and anthocyanin; and any other components having a function of scavenging free radicals or eliminating active oxygen. It is preferable to use a component derived from a natural material.

In the invention, the food material comprising the component(s) having an antioxidation ability comprises at least one of the foregoing components having an antioxidation ability, and includes, in addition to the food material such as coffee, tea, cacao, fruit juice and vegetable juice, a purified product of the foregoing component or a food additive comprising one or more of the foregoing components. The food material in a liquid form is used as such, while a powder form, a solid form or the like is used by being dissolved in water.

In the invention, the mixed liquid is prepared by adding a side material (s), as required, to at least one selected from the food material itself, an extracted liquid of the food material (coffee, black tea, Chinese tea, green tea or the like) and an extract thereof, and adjusting the product volume. Examples of the side material include a milk composition selected from raw milk, skim milk, milk powder, skim milk powder, concentrated milk and other various milk-derived compositions; pH adjustors such as sodium bicarbonate; vitamin C, vitamin E; emulsifying agents such as sucrose fatty acid ester, glycerin fatty acid ester, sorbitan fatty acid ester and soybean phospholipid; oxidation inhibitors; antioxidants; saccharides such as glucose, fructose, maltose, sucrose, trehalose, raffinose and starch; sugar alcohols such as erythritol and maltose; sweeteners; flavors; enzymes; stabilizers; and the like.

Products prepared by adding flavors, sugars, sugar alcohols, other saccharides, sweeteners, sour seasonings and other additives to a fruit juice, a fruit paste and the like are also included in the mixed liquid. Products further containing at least one of the foregoing components having an antioxidation ability are also included in the mixed liquid.

The thus-prepared mixed liquid and/or the food material is then subjected to the electrolysis treatment and/or the current passage treatment. These treatments may be conducted in the same manner as in the foregoing coffee drinks or the milk-containing drinks.

The foregoing food material is subjected to the electrolysis treatment and/or the current passage treatment to provide the food material having an improved antioxidation ability. The thus-obtained material can be sealed and preserved, or a food may be produced using said food material (without the electrolysis treatment or the current passage treatment).

It is also possible that one of the following (1) to (3) is used,

(1) a food material containing at least one antioxidation ability as such,

(2) a food material containing at least one antioxidation ability, which material is subjected to the electrolysis treatment and/or the current passage treatment, and

(3) a food material having no antioxidation ability, which material is subjected to the electrolysis treatment and/or the current passage treatment,

and is mixed with other material (s) to prepare a mixed liquid which is then subjected to the electrolysis treatment and/or the current passage treatment.

(Incidentally, a process in which a mixed liquid prepared using only a food material having no antioxidation ability is subjected to the electrolysis or current passage treatment is not included in (1) to (3).)

Examples of application foods are as follows. With respect to application examples, in addition to coffee and fruit juice, application to overall drinks including tea drinks, soups, milk drinks, sports drinks containing various effective components, health drinks and the like is possible. Further, in the case of coffee, tea drinks and fruit juice drinks, a liquid obtained by extraction or squeezing may be subjected to the electrolysis treatment and/or the current passage treatment, and then concentrated or dried. The thus-obtained foods can be preserved while keeping the improved antioxidation ability, by being filled in containers and sealed.

The invention may also be practiced in a deoxidated condition, and the deterioration of components is not caused by virtue of deoxidation. That is, when an oxidative deterioration is more prevented by deoxidation, components are less changed, and the deterioration of quality can be suppressed. It is quite effective for maintaining the health foods good in taste and flavor over a long period of time.

The thus-obtained foods good for health are filled in containers and sealed in a usual manner, and, as required, pasteurized to provide drinks filled in sealed containers. The practice in the deoxidated condition and the production of the drinks filled in containers may be conducted in the same manner as in the foregoing coffee drinks or milk-containing drinks.

With respect to the foods good for health according to the invention, non-limitative embodiments are described below.

### EMBODIMENT 1

A process for producing a food material having an improved antioxidation ability (radical-scavenging activity), characterized by subjecting a food material containing at least one component having an antioxidation ability (radical-scavenging activity) to an electrolysis treatment and/or a current passage treatment.

### EMBODIMENT 2

A process for producing a food, characterized by preparing the food material according to embodiment 1, and producing the food using the same.

### EMBODIMENT 3

A process for producing a food having an improved antioxidation ability (radical-scavenging activity), characterized by preparing a mixed liquid using a food material containing at least one component having an antioxidation ability (radical-scavenging activity), and subjecting the resulting mixed liquid to an electrolysis treatment and/or a current passage treatment.

### EMBODIMENT 4

A process for producing a food having an improved antioxidation ability (radical-scavenging activity), characterized by preparing a mixed liquid using a food material obtained by subjecting a component having an antioxidation ability (radical-scavenging activity) to an electrolysis treatment and/or a current passage treatment, and subjecting the resulting mixed liquid to an(the) electrolysis treatment and/or a(the) current passage treatment.

### EMBODIMENT 5

The process recited in any one of embodiments 1 to 4, characterized in that in the electrolysis treatment, a desired product is collected from the cathode side (reduction side).

### EMBODIMENT 6

A food material or food having an improved antioxidation ability (radical-scavenging activity), which is produced by the process according to any one of embodiments 1 to 5.

### EMBODIMENT 7

A method for improving an antioxidation ability (radical-scavenging activity) of a food material or food, characterized in that electrolysis treatment and/or current passage treatment is conducted thereto.

The invention is illustrated specifically below by referring to Examples.

(A) Coffee Drinks

### EXAMPLE A1

10 kg of coffee beans was extracted with 100 L of hot water to obtain a coffee extracted liquid (so-called regular coffee; coffee solid content Brix 3.0). Subsequently, this coffee extracted liquid was passed through an electrolytic device of ARV Company at a rate of 4 liters per minute, while a DC current of 5 A was passed therethrough, wherein the anode and the cathode were partitioned with an ion exchange membrane, and the coffee extracted liquid was passed through both the electrode sides, and the liquid of the cathode side was collected. Sodium bicarbonate was added thereto at an amount ratio of 0.3 g/L of the liquid and mixed therewith. The resulting mixed liquid was filled in cans, and pasteurized in a retort (F₀=4 or more) to obtain a coffee drink.

### EXAMPLE A2

10 kg of coffee beans was extracted with 100 L of hot water. To the thus-obtained coffee extracted liquid (coffee solid content Brix 3.0), was added sodium bicarbonate at an amount ratio of 0.3 g/L of the liquid, and they were mixed. The resulting mixed liquid was passed through an electrolytic device of ARV Company at a flow rate of 4 liters per minute, while a DC current of 5 A was passed therethrough, wherein the anode and the cathode were partitioned with an ion exchange membrane, and the mixed liquid was passed through both the electrode sides. The liquid of the cathode side was then collected, filled in cans, and pasteurized in a retort (F₀=4 or more) to obtain a coffee drink.

### EXAMPLE A3

10 kg of coffee beans was extracted with 100 L of hot water. To the thus-obtained coffee extracted liquid (coffee solid content Brix 3.0), was added sodium bicarbonate at an amount ratio of 0.3 g/L of the liquid, and they were mixed. The resulting mixed liquid was held in a tank, and a DC current of 5 A was passed therethrough for 5 seconds by inserting electrodes without a diaphragm. After the current passage, the mixed liquid was filled in cans, and pasteurized in a retort to obtain a coffee drink.

### EXAMPLE A4

Electrodes were installed in a pipe, and the mixed liquid of the coffee extracted liquid and sodium bicarbonate obtained in the foregoing Example was passed through the pipe to conduct the current passage treatment (with no diaphragm) of the mixed liquid under the following conditions. Incidentally, the current passage time was controlled by changing the flow rate in the pipe.

current: 10 A

current passage time: Current passage treatment was conducted for 1 second.

### COMPARATIVE EXAMPLE A

Sodium bicarbonate was added, at an amount ratio of 0.3 g/L of the following coffee extracted liquid, to a coffee extracted liquid (coffee solid content Brix 3.0) obtained by extracting 10 kg of coffee beans with 100 L of hot water, and they were mixed. The resulting mixed liquid was filled in containers, and pasteurized in a retort (F₀=4 or more) to obtain a coffee drink.

(Test Results: Evaluation 1)

The drinks obtained in Example A1 and Comparative Example A were drunk by 15 coffee expert panelists including 5 coffee expert testers. Consequently, it was found that the coffee drink obtained in Example A1 was strong in flavor and coffee feel and good in quality as compared with the coffee drink obtained in Comparative Example A and the former has, like regular coffee, an excellent taste and flavor inherent in coffee (Table A1).

TABLE A1

| | Example A1 | Comparative Example A |
|---|---|---|
| Flavor | 4.3 | 3.7 |
| Bitter taste | 3.6 | 3.1 |
| Acidic taste | 1.9 | 1.1 |
| Aftertaste | 2.2 | 1.4 |
| Coffee feel | 2.4 | 1.8 |
| Total evaluation | 3.2 | 2.9 |

6 (good) [symbol] (bad) 0
In the table, seven scores, “very good” = 6, “good” = 5, “slightly good” = 4, “common” = 3, “slightly bad” = 2, “bad” = 1, and “very bad” = 0, were employed in the evaluation standard.

(Test Results: Evaluation 2)

With respect to the drinks obtained in Examples A1, A2 and A3 and Comparative Example A, those just after the production and those preserved under acceleration conditions with time (at 60° C. for 3 weeks) were subjected to instrumental analysis respectively to analyze an amount of chlorogenic acid, a total amount of organic acids and the change thereof. As a result, it was found that the reduction rate of chlorogenic acid with time was suppressed (Table A2), and that the amount of organic acids which causes quality deterioration was decreased and the increase in its amount with time was suppressed (Table A3). Consequently, it was possible to obtain the high-quality stable coffee drinks with less quality deterioration.

TABLE A2
Amount of chlorogenic acid (%)

| | | | Example | Comparative |
|---|---|---|---|---|
| | Example A1 | Example A2 | A3 | Example A |
| Just after | 100 | 100 | 100 | 100 |
| production | | | | |
| 60° C., 3 weeks | 97 | 94 | 96 | 89 |

TABLE A3
Total amount of organic acids (ppm)

| | | | Example | Comparative |
|---|---|---|---|---|
| | Example A1 | Example A2 | A3 | Example A |
| Just after | 574.4 | 626.2 | 544.0 | 702.9 |
| production | | | | |
| 60° C., 3 weeks | 660.7 | 635.2 | 606.9 | 861.9 |

(B) Milk-Containing Drinks

### EXAMPLE B1

A milk-containing coffee was produced according to the following recipe, and effects of preventing deterioration of stability, flavor and quality thereof by a current passage treatment and an electrolysis treatment were tested. In the following Examples B2 to B4 and Comparative Examples B1 and as well, the respective milk-containing coffee drinks were produced according to the same recipe.

(Recipe used in producing milk-containing coffee drinks)

| | Production of 500 L |
|---|---|
| Coffee beans | 10.0 kg |
| Sodium bicarbonate | 0.25 kg |
| Sugar | 26.5 kg |
| Milk | 165.0 kg |
| Emulsifying agent | 0.6 kg |
| (sucrose fatty acid ester) | |

10 kg of coffee beans was extracted with 100 L of hot water to obtain a coffee extracted liquid (so-called regular coffee). Then, sodium bicarbonate and sugar were added to this coffee extracted liquid. This mixture was further mixed with milk (containing an emulsifying agent) subjected to a current passage treatment (at 10 A for 0.02 second), followed by adjusting the final volume of the product to 500 L. Subsequently, the resulting product was filled in cans, and pasteurized in a retort (F₀=40 or more) to obtain a milk-containing coffee drink.

### EXAMPLE B2

10 kg of coffee beans was extracted with 100 L of hot water to obtain a coffee extracted liquid (so-called regular coffee). Then, sodium bicarbonate and sugar were added to this coffee extracted liquid. This mixture was further mixed with milk (containing an emulsifying agent) subjected to an electrolysis treatment, followed by adjusting the final volume of the product to 500 L. Subsequently, the resulting product was filled in cans, and pasteurized in a retort (F₀=40 or more) to obtain a milk-containing coffee drink.

Incidentally, the electrolysis treatment was conducted by using an electrolytic device of ARV Company (using an ion exchange membrane), passing the liquid at a flow rate of 4 liters per minute while passing a DC current of 5 A.

### EXAMPLE B3

10 kg of coffee beans was extracted with 100 L of hot water to obtain a coffee extracted liquid (so-called regular coffee). Then, sodium bicarbonate and sugar were added to this coffee extracted liquid. This mixture was further mixed with milk (containing an emulsifying agent), followed by adjusting the final volume of the product to 500 L. Subsequently, the resulting product was subjected to an electrolysis treatment, filled in cans, and pasteurized in a retort (F₀=40 or more) to obtain a milk-containing coffee drink.

The electrolysis treatment of the mixed liquid was conducted as in Example B2 using the device of ARV Company. In these Examples, after the electrolysis treatment, the overall liquid in the electrolytic cell was collected, and subjected to the subsequent treatments. Only the liquid on the cathode side may be collected and used as required; in this case, a product better in stability, taste and mouth feel is obtained, though yield and a production efficiency are decreased.

### EXAMPLE B4

10 kg of coffee beans was extracted with 100 L of hot water to obtain a coffee extracted liquid (so-called regular coffee). Then, sodium bicarbonate and sugar were added to this coffee extracted liquid. This mixture was further mixed with milk (containing an emulsifying agent) subjected to an electrolysis treatment, followed by adjusting the final volume of the product to 500 L. Subsequently, the resulting product was subjected to UHT pasteurization (F₀=60 or more), and filled in PET bottles to obtain a milk-containing coffee drink.

Incidentally, the electrolysis treatment was conducted by using an electrolytic device having an electrolytic cell with no membrane (manufactured by ARV Company), passing the liquid at a flow rate of 4 liters per minute while passing a DC current of 10 A.

### COMPARATIVE EXAMPLE B1

Sodium bicarbonate and sugar were added to an extracted liquid obtained by extracting 10 kg of coffee beans with 100 L of hot water, and the mixture was further mixed with milk containing an emulsifying agent, followed by adjusting the final volume of the product to 500 L. Then, the mixed liquid was filled in containers, and pasteurized in a retort (F₀=40 or more) to obtain a milk-containing coffee drink.

### COMPARATIVE EXAMPLE B2

Sodium bicarbonate and sugar were added to an extracted liquid obtained by extracting 10 kg of coffee beans with 100 L of hot water, and the mixture was further mixed with milk containing an emulsifying agent, followed by adjusting the final volume of the product to 500 L. Then, the mixed liquid was subjected to UHT pasteurization (F₀=60 or more) and filled in containers to obtain a milk-containing coffee drink.

(Test Results: Evaluation 1)

The drinks obtained in Example B1 and Comparative Example B1 were drunk by 15 coffee expert panelists including 5 coffee expert testers. Consequently, it was found that the drink in Example B1 was strong in flavor and intrinsic taste of milk and good in sweetness and coffee feel as compared with the drink obtained in Comparative Example B1, and had the well-balanced taste and flavor (Table B1).

TABLE B1

| | Example B1 | Comparative Example B1 |
|---|---|---|
| Flavor | 4.1 | 3.3 |
| Sweetness | 3.6 | 3.3 |
| Coffee feel | 3.1 | 2.5 |
| Rich taste | 3.9 | 3.5 |
| Aftertaste | 3.5 | 3.1 |
| Total evaluation | 3.5 | 2.7 |

6 (good) [symbol] (bad) 0
In the table, seven scores, “very good” = 6, “good” = 5, “slightly good” = 4, “common” = 3, “slightly bad” = 2, “bad” = 1, and “very bad” = 0, were employed in the evaluation standard.

(Test Results: Evaluation 2)

With respect to the drinks obtained in Examples B1, B2 and B3 and Comparative Example B1, the cans of those just after the production and the cans of those preserved under acceleration conditions with time (at 60° C. for 2 weeks) were opened, and an amount of precipitate was measured by centrifugation (3,000 rpm, 10 minutes). As a result, it was found that in Examples B1, B2 and B3, the precipitate less generated in the production than in Comparative Example B1, an excellent effect was brought forth in suppressing the generation of precipitate during preservation and the milk-containing coffee drinks having a stable emulsified state were provided (Table B2).

TABLE B2

| | | | Example | Comparative |
|---|---|---|---|---|
| | Example B1 | Example B2 | B3 | Example B1 |
| Just after | 0.3% | 0.3% | 0.2% | 0.8% |
| production | | | | |
| 60° C., 2 weeks | 1.8% | 1.0% | 0.7% | 4.3% |

(Test Results: Evaluation 3)

The bottles of the drinks obtained in Example B4 and Comparative Example B2 were opened, and an amount of precipitate was measured by centrifugation (3,000 rpm, 10 minutes). As a result, it was found that in Example B4, an excellent effect was exhibited in suppressing the formation of precipitate as compared with Comparative Example B2 and the milk-containing coffee drink having a stable emulsified state was provided. At the same time, scorching of the plate in the UHT pasteurization was tested. The amount of scorched scales was smaller in Example B4 (Table B3).

TABLE B3

| | Example B4 | Comparative Example B2 |
|---|---|---|
| Amount of | 0.2% | 6.5% |
| precipitate | | |

### EXAMPLE B5

Milk tea was produced according to the following recipe, and the effect of preventing the deterioration of stability, taste and quality by a current passage treatment was tested. In Comparative Example B3 below, a milk-containing tea was produced according to the same recipe.

(Recipe used for production of milk tea)

| | kg/1,000 L |
|---|---|
| Black tea leaves | 8.0 |
| Sodium bicarbonate | 0.2 |
| Sugar | 64.0 |
| Milk | 260.0 |
| Emulsifying agent | 1.5 |
| (sucrose fatty acid ester) | |

A pH adjustor and sugar were added to tea extracted liquid obtained by extracting 8 kg of black tea leaves with 120 L of hot water, and the mixture was further mixed with milk containing an emulsifying agent and subjected to a current passage treatment (at 10 A for 0.02 second), followed by adjusting the final volume of the product. The resulting product was filled in containers, and pasteurized in a retort (F₀=40 or more) to obtain milk tea (a milk-containing tea).

### COMPARATIVE EXAMPLE B3

A pH adjust or and sugar were added to tea extracted liquid obtained by extracting 8 kg of black tea leaves with 120 L of hot water, and the mixture was further mixed with milk containing an emulsifying agent, followed by adjusting the final volume of the product. The resulting product was filled in containers, and pasteurized in a retort (F₀=40 or more) to obtain milk tea (a milk-containing tea).

(Test Results: Evaluation 4)

The drinks obtained in Example B5 and Comparative Example B3 were drunk by 15 tea expert panelists. Consequently, it was found that the drink in Example B5 was strong in flavor and rich in taste of milk and good in quality as compared with the drink obtained in Comparative Example B3 and had the well-balanced taste and flavor.

TABLE B4

| | Example B5 | Comparative Example B3 |
|---|---|---|
| Flavor | 3.9 | 3.2 |
| Milk feel | 4.1 | 3.2 |
| Sweetness | 3.5 | 2.8 |
| Tea feel | 3.9 | 3.6 |
| Rich taste | 3.9 | 3.0 |
| Aftertaste | 3.9 | 2.5 |
| Total evaluation | 4.2 | 3.2 |

6 (good) [symbol] (bad) 0
(Evaluation standard is as shown previously.)

(C) Foods Having an Improved Antioxidation Ability

### EXAMPLE C1

10 kg of coffee beans was extracted with 100 L of hot water to obtain a coffee extracted liquid (so-called regular coffee: coffee solids content Brix 3.0). Subsequently, the coffee extracted liquid was passed through an electrolytic device of ARV Company at a rate of 4 liters per minute, while a DC current of 5 A was passed, wherein the anode and the cathode were partitioned with an ion exchange membrane, and the coffee liquid was passed through both the electrode sides. Then, the liquid of the cathode side was collected, and 43 g of sodium bicarbonate was added thereto, followed by adjusting the final volume of the product to 143 L. The resulting liquid was filled in cans, sealed, and then pasteurized in a retort (F₀=4 or more) to obtain a coffee drink.

For comparison with Example C1, the following Comparative Example C1 was performed at the same time.

### COMPARATIVE EXAMPLE C1

43 g of sodium bicarbonate was added to a coffee extracted liquid (so-called regular coffee: coffee solid content Brix 3.0) obtained by extracting 10 kg of coffee beans with 100 L of hot water, followed by adjusting the final volume of the product to 143 L. Then, the resulting liquid was filled in cans, sealed, and pasteurized in a retort (F₀=4 or more) to obtain a coffee drink.

(Test Results: Evaluation 1)

With respect to the drinks obtained in Example C1 and Comparative Example C1, an antioxidation ability (radical-scavenging activity) was measured by a method using DPPH to test an antioxidation ability.

Measuring method: 15 μl of a sample was taken, and adjusted to 800 μl by addition of distilled water. Further, 3.2 ml of 0.1 M Tris buffer (pH 7.4) was added thereto, and 4 ml of 500 μM DPPH (1,1-diphenyl-2-picrylhydrazyl) was, further, added thereto. The mixture was allowed to stand in a dark place for 20 minutes, and subjected to HPLC.

With respect to the HPLC conditions, the antioxidation ability was measured from the area of an absorption peak of DPPH with an absorbance detector (at 517 nm), a mobile phase of water:methanol=3:7, an Octyl column and a flow rate of 1 ml/min.

The results of measuring the antioxidation ability are shown on condition that the result of Comparative Example is rated as 100% (Table C1).

TABLE C1

| | Example C1 | Comparative Example C1 |
|---|---|---|
| Antioxidation | 137% | 100% |
| ability of coffee | | |
| drink | | |

From Table 1C, it was found that the radical-scavenging activity, namely, the antioxidation ability to DPPH was higher in Example C1 than in Comparative Example C1. The results revealed that the antioxidation ability of the drink was increased by the electrolysis treatment and therefore the drink treated is healthier for consumers.

(Test Results: Evaluation 2)

The drinks obtained in Example C1 and Comparative Example C1 were compared with respect to the content of chlorogenic acid which is a main antioxidation component of coffee and the content of quinic acid which is one of its decomposition products. The measurement was conducted by HPLC. With respect to the HPLC conditions, the content of chlorogenic acid was measured from the area of an absorption peak with a UV detector (at 270 nm), a mobile phase of 4% acetic acid:methanol=85:15, an ODS column and a flow rate of 1 ml/min. The content of quinic acid was measured from the height of a detection peak with a conductivity detector, a mobile phase of 5 mM perchloric acid, a strongly acidic cation exchange resin (styrene-divinylbenzene copolymer) column and a flow rate of 0.8 ml/min (Table C2).

TABLE C2

| | Chlorogenic acid | | Quinic acid | |
|---|---|---|---|---|
| | (ppm) | | (ppm) | |
| | Example | Comparative | Example | Comparative |
| | C1 | Example C1 | C1 | Example C1 |
| Content in | 655.2 | 673.4 | 946.0 | 944.0 |
| coffee drink | | | | |

As is apparent from Table C2, it was shown that in Example C1, the content of the main antioxidation component of coffee was slightly lower than that in Comparative Example C1.

From the results of Evaluation 1 and Evaluation 2, it is said that although the amount of the main antioxidation component was not increased, the antioxidation ability can be increased by conducting the electrolysis treatment.

### EXAMPLE C2

14 kg of red grapefruit (grown in Florida) was squeezed with an in-line squeezing machine (manufactured by FMC Company), and subjected to enzyme deactivation by heating at 93° C. for 5 seconds and treatment with a pulper finisher. 8 L of the resulting squeezed liquid was subjected to an electrolysis treatment with an electrolytic device having an ion exchange membrane at 7 A. The liquid on the cathode side was collected, and then subjected to a flash pasteurization at 93° C. for 5 seconds. The resulting liquid was hot-packed in cans to obtain a grapefruit juice.

Incidentally, in the electrolysis, the anode and the cathode were partitioned with an ion exchange membrane, and the squeezed liquid was passed through both the electrode sides.

For comparison with Example C2, the following Comparative Example C2 was performed at the same time.

### COMPARATIVE EXAMPLE C2

14 kg of red grapefruit (grown in Florida) was squeezed with an in-line squeezing machine (manufactured by FMC Company), and subjected to enzyme deactivation by heating at 93° C. for 5 seconds and treatment with a pulper finisher. 8 L of the resulting squeezed liquid was subjected to a flash pasteurization at 93° C. for 5 seconds, hot-packed in cans to obtain a grapefruit juice.

### EXAMPLE C3

14 kg of red grapefruit (grown in Florida) was squeezed with an in-line squeezing machine (manufactured by FMC Company), and subjected to enzyme deactivation by heating at 93° C. for 5 seconds and treatment with a pulper finisher. 8 L of the resulting squeezed liquid (Brix 11) was subjected to an electrolysis treatment with an electrolytic device having an ion exchange membrane at 7 A. The liquid of the cathode side was collected, and then concentrated to Brix 33 by a vacuum concentration. The resulting concentrated fruit juice was reduced again to Brix 11 as in squeezing by addition of water, then subjected to flash pasteurization at 93° C. for 5 seconds, hot-packed in cans to obtain a grapefruit juice.

Incidentally, in the electrolysis, the anode and the cathode were partitioned with the ion exchange membrane, and the squeezed liquid was passed through both the electrode sides.

For comparison with Example C3, the following Comparative Example C3 was performed at the same time.

### COMPARATIVE EXAMPLE C3

14 kg of red grapefruit (grown in Florida) was squeezed with an in-line squeezing machine (manufactured by FMC Company), and subjected to enzyme deactivation by heating at 93° C. for 5 seconds and treatment with a pulper finisher. 8 L of the resulting squeezed liquid (Brix 11) was concentrated to Brix 33 by a vacuum concentration. The resulting concentrated fruit juice was reduced again to Brix 11 as in squeezing by addition of water, then subjected to a flash pasteurization at 93° C. for seconds, and hot-packed in cans.

(Test Results: Evaluation 3)

With respect to the juices obtained in Example C2, Comparative Example C2, Example C3 and Comparative Example C3, the antioxidation ability was measured using DPPH to test an antioxidation ability.

Measuring method: 100 μl of a sample was taken, and adjusted to 400 μl by addition of distilled water. Further, 1.6 ml of 0.1 M Tris buffer (pH 7.4) was added thereto, and 2 ml of 500 μM DPPH (1,1-diphenyl-2-picrylhydrazyl) was then added. The mixture was allowed to stand in a dark place for 20 minutes, and subjected to HPLC.

With respect to the HPLC conditions, the antioxidation ability was measured from the area of an absorption peak of DPPH with an absorbance detector (at 517 nm), a mobile phase of water:methanol=3:7, an Octyl column and a flow rate of 1 ml/min.

The results of measuring the antioxidation ability are shown on the condition that the result of Comparative Example is rated as 100% (Table C3).

TABLE C3

| | Comparative | Example | Comparative | Example |
|---|---|---|---|---|
| | Example C2 | C2 | Example C3 | C3 |
| Antioxidation | 100% | 111% | 100% | 153% |
| ability of | | | | |
| grapefruit | | | | |
| juice | | | | |

The radical-scavenging activity, namely, the antioxidation ability to DPPH was higher in Examples C2 and C3 than in Comparative Examples C2 and C3. The results revealed that the antioxidation ability of the liquid was increased by the electrolysis treatment and therefore the drink treated is healthier for consumers.

(Test Results: Evaluation 4)

The drinks obtained in Example C2, Comparative Example C2, Example C3 and Comparative Example C3 were compared with respect to the content of vitamin C of reduced type which is a main antioxidation component of grapefruit.

The measurement was conducted by HPLC. With respect to the HPLC conditions, the content of vitamin C of reduced type was measured from the area of a detection peak with a UV detector (at 250 nm), a mobile phase of acetonitrile:50 mM ammonium dihydrogenphosphate=75:25, a Polyamine II column and a flow rate of 1 ml/min.

The results of measuring vitamin C of reduced type are shown on the condition that the result of Comparative Example is rated as 100% (Table C4).

TABLE C4

| | Comparative | Example | Comparative | Example |
|---|---|---|---|---|
| | Example C2 | C2 | Example C3 | C3 |
| Content in | 100% | 88% | 100% | 92% |
| grapefruit | | | | |
| juice | | | | |

As is apparent from Table C4, it was identified that in Examples C2 and C3, the content of vitamin C of reduced type was slightly lower than that in Comparative Examples C2 and C3.

From Evaluation 3 and Evaluation 4, it was found that although the content of the main antioxidation component was low, the antioxidation ability was effectively increased by conducting the electrolysis treatment.

### EXAMPLE C4

0.1 kg of vitamin C, 4.0 kg of citric acid (anhydride) and 3.0 kg of sugar were added to 30 L of water, and the mixture was adjusted to 100 L with water to obtain a mixed liquid. This mixed liquid was subjected to a current passage treatment under the condition of 10 A, then subjected to a flash pasteurization at 95° C., and hot-packed in cans.

### EXAMPLE C5

0.1 kg of vitamin C, 4.0 kg of citric acid (anhydride) and 3.0 kg of sugar were added to 30 L of water, and the mixture was adjusted to 100 L with water to obtain a mixed liquid. This mixed liquid was subjected to an electrolytic device with an ion exchange membrane under the condition of 10 A, and the liquid obtained from the cathode side was collected. Then, a flash pasteurization was conducted at 95° C., and the resulting liquid was hot-packed in cans. Incidentally, in the electrolysis treatment, the cathode and the anode were partitioned, and the mixed liquid was passed through both the electrode sides.

For comparison with Examples C4 and C5, the following Comparative Example C4 was performed at the same time.

### COMPARATIVE EXAMPLE C4

0.1 kg of vitamin C, 4.0 kg of citric acid (anhydride) and 3.0 kg of sugar were added to 30 L of water, and the mixture was adjusted to 100 L with water to obtain a mixed liquid. This mixed liquid was subjected to a flash pasteurization at 95° C., and hot-packed in cans.

(Evaluation Test: Evaluation 5)

With respect to the drinks obtained in Example C4, Example C5 and Comparative Example C4, the antioxidation ability was measured using DPPH to test an antioxidation ability.

Measuring method: 100 μl of a sample was taken, and adjusted to 400 μl by addition of distilled water. Further, 1.5 ml of 0.1 M Tris buffer (pH 7.4) was added thereto, and 2 ml of 500 μM DPPH (1,1-diphenyl-2-picrylhydrazyl) was then added. The mixture was allowed to stand in a dark place for 20 minutes, and subjected to HPLC.

With respect to the HPLC conditions, the antioxidation ability was measured from the area of an absorption peak of DPPH with an absorbance detector (at 517 nm), a mobile phase of water:methanol=3:7, an Octyl column and a flow rate of 1 ml/min.

The results of measuring the antioxidation ability are shown on condition that the result of Comparative Example is rated as 100% (Table C5).

TABLE C5

| | | | Comparative |
|---|---|---|---|
| | Example C4 | Example C5 | Example C4 |
| Antioxidation | 102% | 110% | 100% |
| ability of drink | | | |

The radical-scavenging activity, namely, the antioxidation ability to DPPH was higher in Examples C4 and C5 than in Comparative Example C4. The results revealed that the antioxidation ability of the liquid was increased by the electrolysis treatment or the current passage treatment and the liquid treated is healthier for consumers.

### EFFECTS OF THE INVENTION

The deterioration of quality can be prevented by conducting the electrolysis treatment and/or the current passage treatment.

In coffee drinks, it is possible to control the rate of reduction with time of chlorogenic acid which is a component in coffee or to control the amounts of formed lactic acid, formic acid and acetic acid which decrease quality.

Consequently, it is possible to prevent the quality deterioration of drinks in vending machines installed not only indoors but also outdoors, can warmers and the like, to extend the time in hot vending and to extend the period within which drinks can safely be drunk whereby the shelf life is prolonged. Further, when the production steps of the process are performed in the deoxidated condition, it is possible to further control quality deterioration or improve stability.

In the milk-containing drinks, the electrolysis treatment and/or the current passage treatment helps to increase the quality and improve the stability of milk. Because of the stabilization, the use of a pH adjustor, an emulsifying agent, a stabilizer and the like which have been so far used can be reduced; resultantly it is possible to depress the use of many additives.

As a result, it is possible to prevent the quality deterioration of drinks (prevention of precipitation of milk) in vending machines, can warmers and the like, to extend the time in hot vending machines and to extend the period within which drinks can safely be drunk. Further, it is possible to prevent the formation of scales on a plate in pasteurization with a plate heater, such as UHT pasteurization, which leads to the improvement in a production efficiency.

Moreover, it has been found for the first time by the present inventors that when a component(s) having an antioxidation ability, namely, a radical-scavenging activity is(are) subjected to the electrolysis or current passage treatment, the antioxidation ability (radical-scavenging activity) is improved.

When a liquid food containing a component(s) having an antioxidation ability is subjected to the electrolysis treatment and/or the current passage treatment according to the invention, the antioxidation ability is thereby improved. When consumers eat or drink the liquid food treated, the antioxidation component(s) thereof acts(act) in vivo more effectively than the component(s) not subjected to the electrolysis treatment or the current passage treatment, and is(are) expected to contribute to health. Since the electrolysis treatment and/or the current passage treatment is effective for making an antioxidation ability higher than that provided by the amount of the antioxidation component (s) originally present in the liquid, amounts of a material(s) used for increasing an antioxidation ability, especially a food additive(s), can be reduced.

Still further, since an antioxidation ability can be imparted to materials or foods with a less antioxidation ability, even foods that do not function so much as health foods can exhibit functionality for health.

Moreover, since the foregoing prominent effects provided by the invention are brought forth without using a food additive (s), the invention can meet the consumers' needs for either dispensing with, or controlling, various additives such as chemical substances. In this respect as well, the invention is outstanding.

In this manner, the quality of liquid foods such as coffee drinks, milk-containing drinks and foods good for health is improved.

1. A method for producing a liquid food, which comprises:
conducting a current passage treatment of a liquid food as follows:
(1) introducing a liquid food to be treated into a container that is equipped with a cathodic electrode which is an electrode selected from the group consisting of a stainless steel electrode, a platinum-plated titanium electrode and a titanium platinum calcination electrode, and an anodic electrode which is an electrode selected from the group consisting of a ferrite electrode, a platinum-plated titanium electrode and a titanium platinum calcination electrode, the container not equipped with a diaphragm;
(2) passing a direct current of 0.5 to 20 A for 0.001 second to 5 minutes through the liquid food; and
(3) recovering the treated liquid food;
wherein the liquid food to be treated is one which is selected from the group consisting of (a) coffee extract, (b) a milk composition, (c) a black tea extract, (d) a Chinese tea extract, (e) a green tea extract, and (f) a member selected from the group consisting of items (a) to (e) which in addition contains at least one material selected from the group consisting of a pH adjustor, vitamin C, vitamin E, emulsifying agents, antioxidants, saccharides, sugar alcohols, non-saccharide sweeteners, flavoring agents, enzymes and stabilizers.

2. The method according to claim 1, wherein the liquid food for treatment in step (1) is introduced into the container by flowing the liquid food continuously through the device.

3. A method for producing a liquid, which comprises:
conducting a current passage treatment of a liquid to be used for the preparation of a liquid food as follows:
(1) introducing a liquid to be treated into a container that is equipped with a cathodic electrode which is an electrode selected from the group consisting of a stainless steel electrode, a platinum-plated titanium electrode and a titanium platinum calcination electrode, and an anodic electrode which is an electrode selected from the group consisting of a ferrite electrode, a platinum-plated titanium electrode and a titanium platinum calcination electrode, the container not equipped with a diaphragm;
(2) passing a direct current of 0.5 to 20 A for 0.001 second to 5 minutes through the liquid; and
(3) recovering the treated liquid;
wherein the liquid to be treated is one which is selected from the group consisting of (a) coffee extract, (b) a milk composition, (c) a black tea extract, (d) a Chinese tea extract, (e) a green tea extract, and (f) a member selected from the group consisting of items (a) to (e) which in addition contains at least one material selected from the group consisting of a pH adjustor, vitamin C, vitamin E, emulsifying agents, antioxidants, saccharides, sugar alcohols, non-saccharide sweeteners, flavoring agents, enzymes and stabilizers.

4. The method according to claim 3, wherein the liquid for treatment in step (1) is introduced into the container by flowing the liquid food continuously through the device.
